(19) United States
(12) Patent Application Publication
(10) Pub. No.: US 2009/0017833 A1
(43) Pub. Date: Jan. 15, 2009

(54) Co-ordinating the Sharing of a Radio Transmission Resource

(75) Inventors: Daniel Reiter, Lindley (GB); Ravi Shankar Kuppan, West Bridgford (GB); Vaibhav Bhalchandra Kulkarni, Ameerpet (IN)

Correspondence Address: RICHARD M. GOLDBERG, 25 EAST SALEM STREET, SUITE 419, HACKENSACK, NJ, 07601, US

(73) Assignee: TARANTULA.NET LIMITED, Slough (GB)

(21) Appl. No.: 12/147,936

(22) Filed: Jun. 27, 2008

(30) Foreign Application Priority Data
Jun. 28, 2007 (GB) 07 12 591.7

(51) Int. Cl. H04Q 7/20

(52) U.S. Cl. 455/450

(57) ABSTRACT

A web based server system is disclosed and facilitates the sharing of a radio transmission resource. The state owners have locations at which radio transmission equipment may be located, possibly sharing with existing equipment. Service providers control transmission equipment at selected locations and provide a radio service. Contractors erect equipment at the selected locations in response to orders placed by service providers. An authority wishes to maximise the sharing of existing locations and thereby minimise the use of new green field locations. The server system is configured to establish an on-line market that facilitates the creation of contracts between estate owners and service providers. The execution of the contracts are monitored by receiving progress data from contractors service providers and estate owners. Contract specific data and enterprise specific data is made available to each of the contractors, service providers and estate owners. In addition, industry-wide information relating to the sharing of resources is made available to the authorities.

### TECHNICAL FIELD

The present invention relates to a method of co-ordinating the sharing of a radio transmission resource and a server configured to facilitate coordinating the sharing of a radio transmission resource.

### BACKGROUND OF THE INVENTION

Increasing use is being made of public radio networks both for mobile cellular telephone systems and for computer networks, using protocols such as GSM, 3G, 4G and WiFi or WiMAX respectively.

In order to provide local coverage, wide area coverage or national coverage, it is necessary to establish a network of radio transmission resources, such as transmission masts, onto which radio transmitters and associated communication equipment may be located.

In many environments, authorities (both local government and national government), often express an interest in the activities of the service providers. Often, for economic reasons, they wish to encourage the establishment of radio communication networks but at the same time they often wish to limit the impact of the installation hardware upon the environment. It is also understood that environmental impact may be reduced if existing locations are shared with a plurality of service providers. Authorities are therefore often desirous of maximising the sharing of existing locations and minimising the use of new green field locations. Similarly, estate owners often charge rent to service providers for providing locations for their equipment and as such it is to their benefit to optimise rental income by facilitating the sharing of locations wherever this is possible. Costs to service providers may be reduced if instead of establishing a green field location for equipment, it is possible for them to make use of existing equipment or at least make use of an existing geographical location, with additional hardware provision being made where appropriate.

In many environments authorities express concern that they do not consider the sharing of resources to be optimised. However, a problem exists in that service providers are often under pressure to satisfy demand for coverage and therefore exhaustive searches to identify sharing opportunities may, from the provider's perspective, be a less than an optimum use of available resources.

### BRIEF SUMMARY OF THE INVENTION

According to a first aspect of the present invention, there is provided a method of coordinating the sharing of a radio transmission resource, wherein estate owners have locations at which radio transmission equipment may be located, possibly sharing with existing equipment; service providers control transmission equipment at selected locations and provide a radio service; contractors erect equipment at said selected locations in response to orders placed by service providers; and an authority is desirous on maximising the sharing of existing locations and minimising the use of new green field locations, comprising the steps of: establishing an on-line market that facilitates the creation of contracts between estate owners and service providers; monitoring the execution of said contracts by receiving progress data from contractors, service providers and estate owners; making contract specific data and enterprise specific data available to each of the contractors, service providers and estate owners; and making industry-wide information relating to the sharing of resources available to said authority.

### BRIEF DESCRIPTION OF THE SEVERAL VIEWS OF THE DRAWINGS

FIG. 1 shows a radio transmission resource;

FIG. 2 shows an alternative configuration to that shown in FIG. 1;

FIG. 3 illustrates the co-ordination of sharing radio transmission resources;

FIG. 4 illustrates an inter-play between the entities identified in FIG. 3;

FIG. 5 illustrates operations performed by the server identified in FIG. 3;

FIG. 6 details procedures for facilitating the finding of locations, identified in FIG. 5;

FIG. 7 illustrates procedures for overseeing the installation of equipment, identified in FIG. 5; and

FIG. 8 details procedures for the generation of reports, identified in FIG. 5.

### DESCRIPTION OF THE BEST MODE FOR CARRYING OUT THE INVENTION

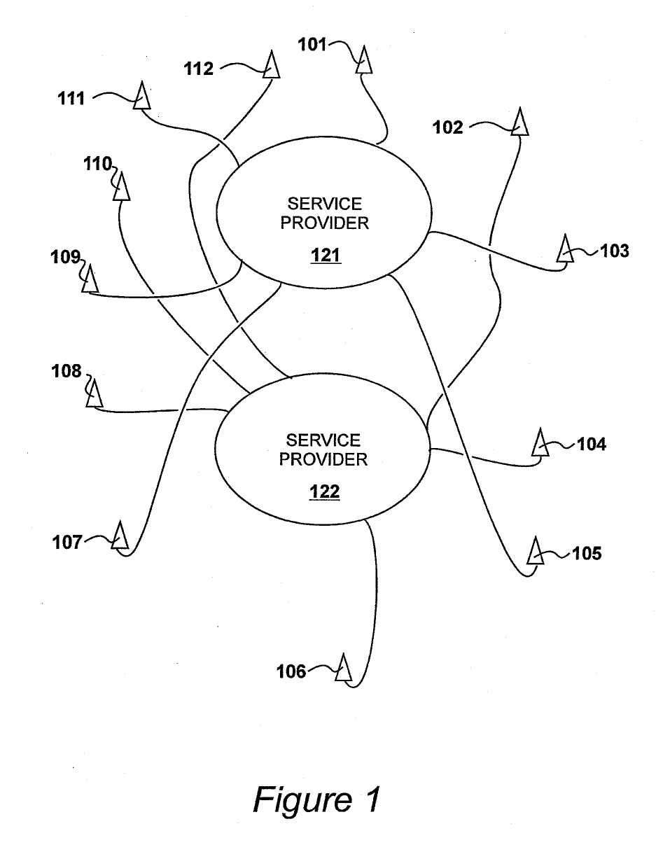

### FIG. 1

A radio transmission resource is illustrated in FIG. 1 in which estate owners have provided locations 101 to 112 at which radio transmission equipment may be located. In this example, a first service provider 121 is shown with a second service provider 122. Furthermore, in this example, half of the locations (101, 103, 105, 107, 109 and 111) are being used by service provider 121 and the other half of the locations (namely 102, 104, 106, 108, 110 and 112) are being used by service provider 122. All regions within the environment are able to receive a service from both service provider 121 and service provider 122. In other environments, such as a mobile telephone environment, more than two service providers may provide coverage throughout the environment. Thus, extending the model shown in FIG. 1, it would be necessary for each service provider to establish their own network of locations thereby substantially increasing the number of locations required in order to provide a service throughout the environment. Many authorities, although keen to see the growth of radio networks of this type, would not sanction this excessive use of locations for the establishment of radio transmission equipment and the service providers themselves would be under some pressure to reduce the total number of geographical locations used.

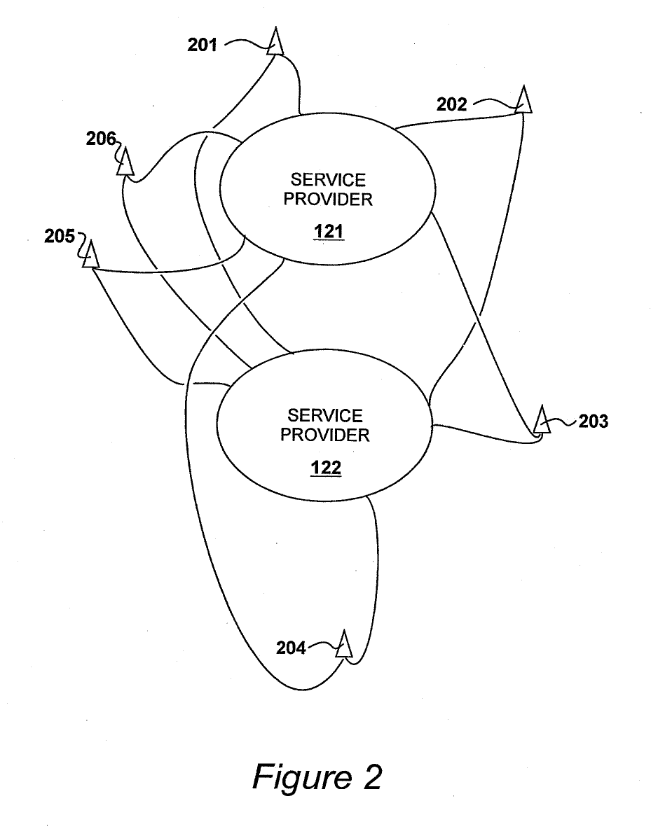

### FIG. 2

An alternative configuration is illustrated in FIG. 2 in which both service provider 121 and service provider 122 provide substantially similar coverage in this environment compared to the environment of FIG. 1. However, in the environment of FIG. 2, the number of locations on which transmission equipment has been established has been reduced by half, such that only six transmission locations have been created, namely 201 to 206. However, in the environment of FIG. 2, each location is being shared by the two service providers providing service within the environment.

In many national networks, the number of service providers will be greater than two and the number of locations for the provision of radio transmission service will be extremely large, typically in the tens of thousands. These locations may be shared between mobile cellular telephone providers and may also be shared with other radio network providers, such as WiFi hotspot providers. It can therefore be seen that the number of permutations and sharing possibilities is extremely large. A problem therefore exists in terms of working towards an optimised solution in which the requisitioning of new green field sites is minimised while at the same time the use of existing sites is optimised. Existing sites may be sites currently hosting radio transmission services, or existing structures such as buildings, water towers etc which are not yet hosting radio transmission services. Service providers are thereby allowed to establish new networks and to enhance existing networks, without undue limitations being placed on the time scales for achieving operational service.

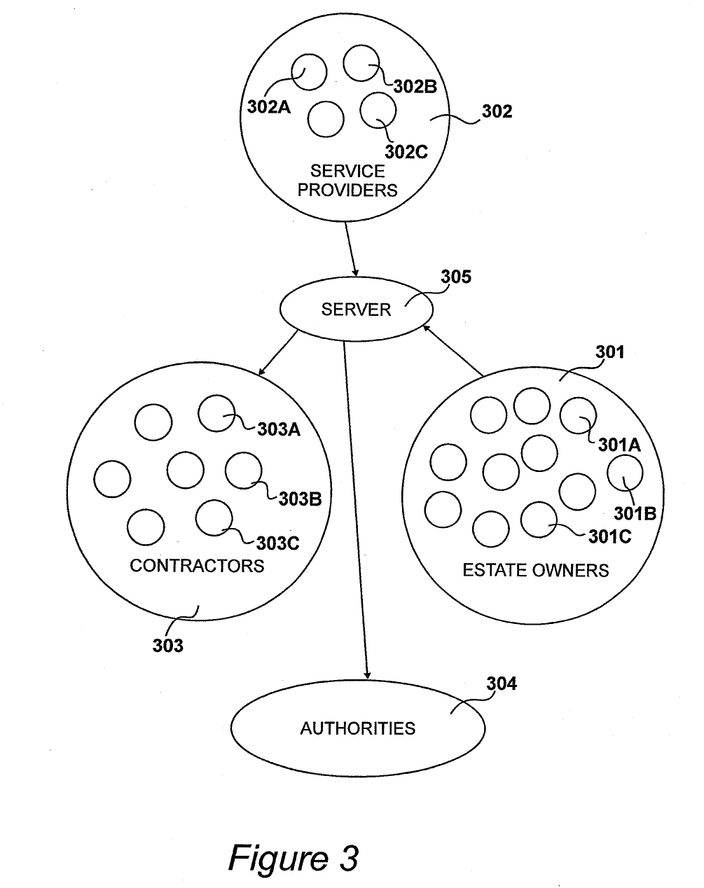

### FIG. 3

In a preferred embodiment of the present invention, the co-ordination of the sharing of radio transmission resources is facilitated. Estate owners 301 have locations 301A, 301B, 301C, etc at which radio transmission equipment may be located, possibly sharing with existing equipment. Further facilities may also be shared, such as a power supply, a cabin, an equipment room etc. Service providers 302 control transmission equipment 302A, 302B, 302C, etc at selected locations and provide a radio service. Contractors 303 have contracts 303A, 303B, 303C, etc to erect equipment at the selected locations in response to orders being placed by the service providers 302. Furthermore, authorities 304 wish to maximise the sharing of existing locations, thereby minimising the use of green field locations.

A preferred embodiment of the present invention provides a network server 305 configured to establish an on-line market that facilitates the creation of contracts between the estate owners 301 and the service providers 302. Furthermore, the server 305 monitors the execution of these contracts by receiving progress data from contractors, service providers and estate owners. The server makes contract specific data and enterprise specific data available to each of the contractors, service providers and estate owners. Furthermore, the server 305 makes industry-wide information relating to the sharing of resources available to the authorities 304.

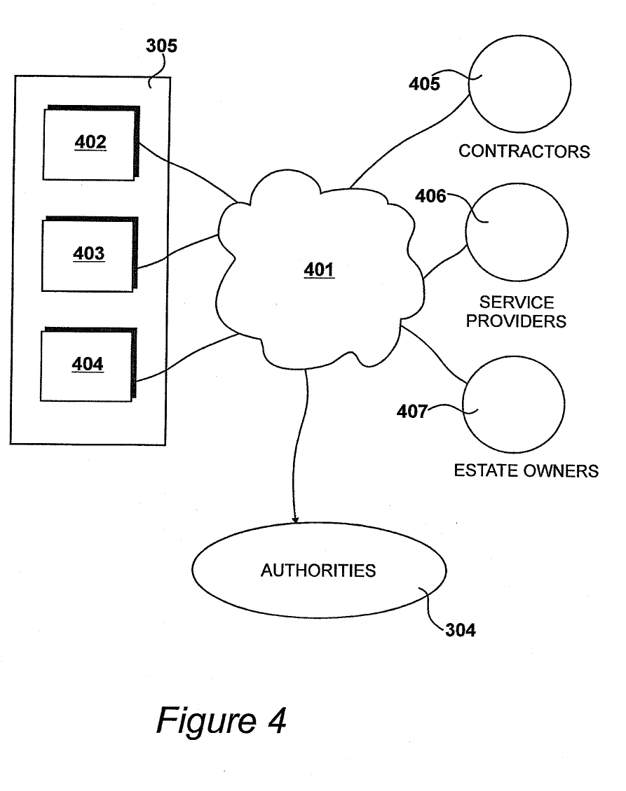

### FIG. 4

The inter-play between the entities illustrated in FIG. 3 is detailed in FIG. 4. Communications take place over a network 401, which may be a publicly available such as the Internet or a private network or a virtual private network established over public communication channels. In this embodiment, server functionality 305 is established by a web server 402, a database server 403 and a historical data server 404. Operation of the database server 403 and the historical data server 404 are coordinated by the web server 402. Consequently, these resources may be locally positioned such that communication occurs internally within the server provision 305. Alternatively, communication may also occur as illustrated in FIG. 4, via network 401. In this example, the authorities 304 receive data via the network 401. In this example, a contractor 405 is shown connected to network 401, with a service provider 406 and an estate owner 407. The authorities 304 wish to encourage the sharing of locations. The service provider 406 is concerned with achieving full network provision at minimal cost and within efficient roll-out time frames. Estate owner 407 wishes to achieve a maximum return from the renting of appropriate locations. Contractors 405 wish to receive orders to establish functionality and wish to be in a position to achieve roll-out in an efficient way, so as to maintain good working relationships and to receive subsequent orders in future.

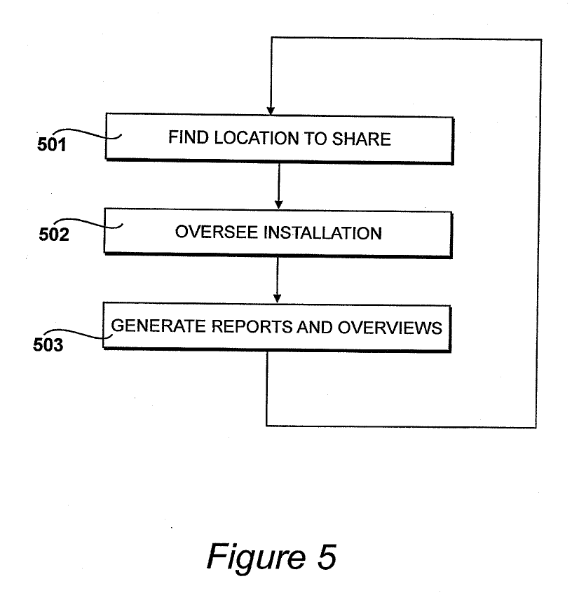

### FIG. 5

Operations performed by the server 305, primarily web server 402, are illustrated in FIG. 5.

At step 501 a location for sharing is found. Following a search conducted by the service provider, a particular location has been identified and the estate owner 407 of that location is prepared to enter a contract with the service provider 406. A typical estate owner would own in the region of two thousand possible locations and these locations would be identified preferably in the form of a web page or web pages, searchable by the service provider 406. Each service provider is preferably provided with their specific branded web pages but all web pages of this type may be searched collectively when a service provider is looking to identify a particular location. Furthermore, from the establishment of the contract, the owner of a server systems 305 would expect to receive a commission on the transaction, thereby financing the ongoing maintenance of the service.

Database server 403 maintains databases showing the availability of particular locations so as to facilitate the finding process 501. In addition, data is also stored relating to work flow, described subsequently.

The environment created by the server system 402 in itself provides information to service providers facilitating the establishment of contracts with estate owners. In some situations, more information may be required and the environment facilitates further communications between specific service providers and estate owners until progress can be made in the establishment of a contract.

Step 502 oversees the installation of particular equipment after a contract has been established. Step 503 generates reports and overviews so that contractors, service providers and estate owners receive contract-specific data relating to particular contracts that they have in place. In addition, step 503 also generates enterprise specific data, such that a particular contractor may receive a report relating to all of their contracts that are in place for the establishment of facilities. Similarly, service providers may receive enterprise specific data relating to all the contracts that they have in place. Similarly, estate owners may receive enterprise specific data showing how their resources are being deployed. In addition, authorities receive industry-wide information relating to the overall sharing of the available resources. Thus the provision of information may be seen as existing at three levels. At the lowest level, information is provided concerning the tracking of an individual relationship for the installation of equipment at a particular location. On the next level (the enterprise level) all information for a particular enterprise, contractor, service provider or estate owner is provided showing how their overall position exists at a particular point in time. Furthermore, at the highest level, data is collected for the industry as a whole. At this level, much of the commercial information may have been filtered out as it may be seen as being commercially sensitive. However, an overview is provided showing the extent to which resources are being shared and thereby authorities may be reassured that sharing procedures are taking place and the use of new green field sites is being minimised.

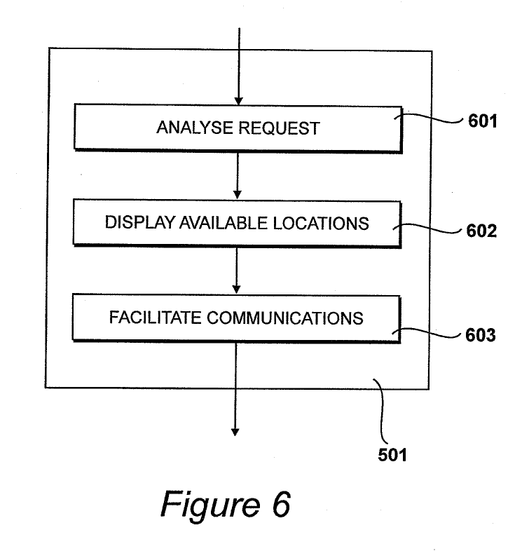

FIG. 6

Procedure 501 for facilitating the finding of locations to share are detailed in FIG. 6.

At step 601 a request is analysed. Primarily, a request will identify a particular geographical location at which a service provider wishes to establish functionality. This may be in order to provide a specific local service, such as a WiFi service or, alternatively, the geographical location may be required in order to extend or complete an existing network, such as a cellular telephone network. It is therefore possible for geographical locations to be identified in a number of different ways, possibly by reference to grid references, possibly including a radius of interest or possibly by providing postcodes etc.

In response to the analysis of the request taking place at step 601, available locations are displayed to the service provider at step 602. Such a display may identify a single location at the area of interest, many locations at the area of interest or it may be unable to identify a suitable location, possibly suggesting that it will be necessary to construct equipment at a green field location.

Thereafter at step 603 and on the assumption that an appropriate location has been identified from those displayed at 602, further communication between the estate owner 407 and the service provider is facilitated at step 603.

In some situations, no further use to the system may be made and the establishment of a contract may be established outside the realms of the system's provision. However, in the preferred deployment, the system oversees the installation of the equipment and by maintaining an overview of the existing environment, provides reports and overviews to the interested parties. Thus, the present inventor has identified an environment in which it is in the interest of all parties to maintain use of the service given that it is possible to achieve a net sum gain for relatively modest outlay.

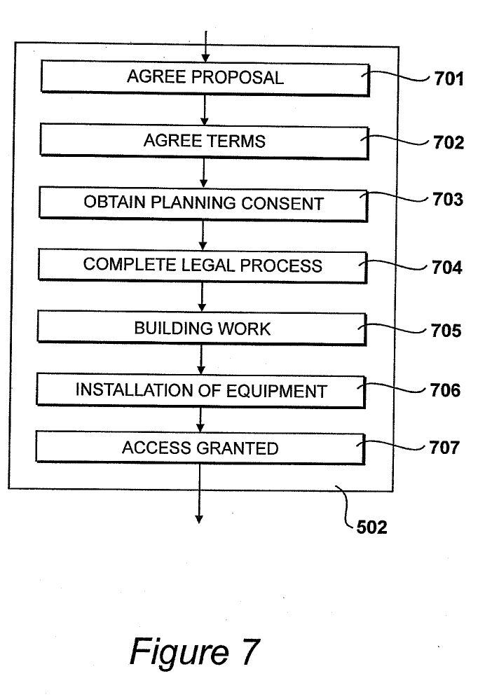

### FIG. 7

Procedures 502 for overseeing the installation of equipment at a shared site is illustrated in FIG. 7. At step 701 the proposal is agreed. Thus, from the perspective of following the progress of the relationship, the database server 403 enters a state which reflects a condition that a proposal is possible in principle, subject to detailed contractual issues being resolved.

Thus, at step 702 terms are agreed and again this state is recorded in the database server 403.

At step 703 planning consent is obtained and again the stage is recorded in the database server. Step 704 represents the completion of the legal process such that the actual building of the site may be initiated.

Step 705 relates to the actual building of equipment, this representing any civil work that may be required. Thus, it is appreciated that in many circumstances, the sharing of a location may be possible, subject to further enhancements being made at that location which in turn may involve the erection of taller towers and other civil engineering operations.

Step 706 represents the installation of electronic equipment, which therefore takes the site from a possibility to an operational reality. Thereafter, at step 707 access to the site is granted and the provision of service then becomes active.

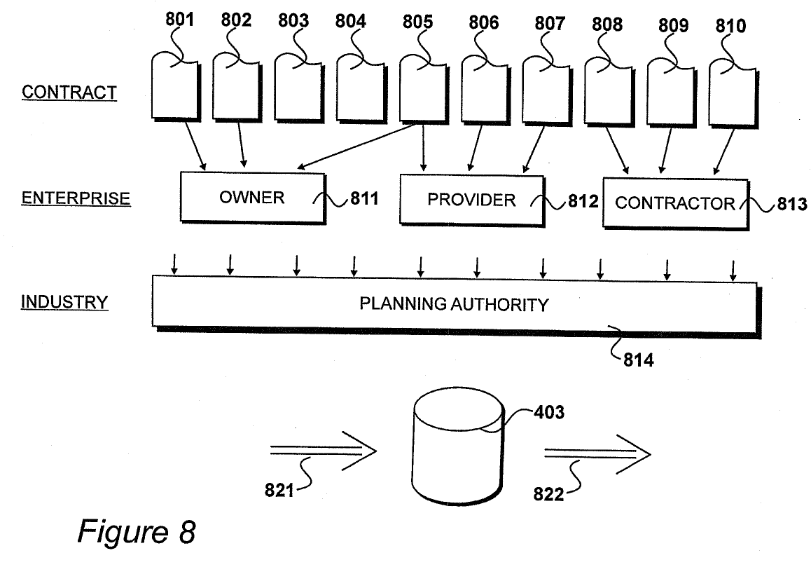

### FIG. 8

Procedures 503 for the generation of reports and overviews are illustrated in FIG. 8. In a preferred embodiment, data relating to all contracts is stored at the database server 403. Using appropriate query language, a query 821 is directed at the database server 403 resulting in data representing the output of the report 822 being generated by the server 403 and returned to the requesting body.

In the preferred embodiment, subsets of queries are available for each of the interested parties, namely the contractor 405, the service provider 406, the estate owner 407 and the authorities 304.

Individual contract specific reports 801 to 810 are illustrated that include all of the relevant data for a particular contract. In particular, this identifies the status of the contract and the extent to which resources are being shared.

In addition to these reports, enterprise reports 811, 812 and 813 are generated in response to appropriate queries. In this example, enterprise report 811 has been generated for a particular owner, such as estate owner 407. In this example, estate owner 407 is presently involved with contracts 801, 802 and 805 therefore data has been obtained from these particular contract data fields.

Similarly, enterprise report 812 is for a service provider, such as service provider 406. Again, in this example, service provider 406 is involved with contracts 805, 806 and 807. Thus, in this particular example, it can be seen that contract 805 is effectively between service provider 406 and estate owner 407.

Enterprise report 813 has been produced for a contractor, such as contractor 405 and in this example, the contractor is involved with contract 808, 809 and 810.

In the preferred embodiment, each contractual relationship is taken through substantially similar processes in substantially the same order which, at any point in time, may represent industry-wide best practice. All of the parties within the environment are therefore encouraged to adopt best practice and by having all of their contractual relationships progressed and reported (as reports 801 to 810) it is then possible to produce higher level reports, at the enterprise level and at the industry-wide level.

An industry-wide report 814 is shown which may have been produced for an appropriate planning authority, an example of authorities 304. This derives information from all of the contracts presently in place and is primarily concerned with the extent to which resources are being shared. Thus, report 814 may identify the average number of service providers present at locations provided by estate owners 407. However, it is also appreciated that queries available to authorities would be somewhat restricted and specific contractual and financial information would generally not be accessible unless appropriate data protection measures have been invoked.

1. A method of coordinating the sharing of a radio transmission resource, wherein estate owners have locations at which radio transmission equipment may be located, possibly sharing with existing equipment;
service providers control transmission equipment at selected locations and provide a radio service;
contractors erect equipment at said selected locations in response to orders placed by service providers; and
an authority is desirous of maximising the sharing of existing locations and minimising the use of new green field locations, comprising the steps of:
establishing an on-line market that facilitates the creation of contracts between estate owners and service providers;
monitoring the execution of said contracts by receiving progress data from contractors, service providers and estate owners;
making contract specific data and enterprise specific data available to each of the contractors, service providers and estate owners; and
making industry-wide information relating to the sharing of resources available to said authority.

2. A method according to claim 1, wherein said radio transmission resources relate to cellular mobile telephones.

3. A method according to claim 1, wherein said locations already have equipment and said locations may be shared.

4. A method according to claim 1, wherein an interest has been registered in said locations by a service provider.

5. A method according to claim 1, wherein said on-line market is established by the provision of a plurality of websites and a search engine.

6. A method according to claim 1, wherein progress data is recorded in a database.

7. A method according to claim 6, wherein said database encourages a best practice approach.

8. A method according to claim 1, wherein commercially sensitive data is restricted, so as not to be available to non-involved parties or to said authorities.

9. Apparatus for serving data to estate owners having locations at which radio transmission equipment may be located and possibly shared with existing equipment in an environment comprising:
service providers having control over transmission equipment at selected locations to provide a radio service;
contractors having agreements to erect equipment at said selected locations in response to orders placed by service providers; and
authorities desirous of maximising the share of existing locations, wherein said apparatus is configured to:
establish an on-line market that facilitates the creation of contracts between estate owners and service providers;
monitor the execution of said contracts by receiving progress data from contractors, service providers and estate owners;
makes contract specific data and enterprise specific data available to each of the contractors, service providers and estate owners; and
make industry-wide information relating to the sharing of resources available to said authority.

10. Apparatus according to claim 9, wherein the radio transmission resources relate to cellular mobile telephones.

11. Apparatus according to claim 9, wherein the locations already have equipment that may be shared.

12. Apparatus according to claim 9, wherein an interest has been registered in said locations by a service provider.

13. Apparatus according to claim 9, wherein the on-line market is established by the provision of a plurality of websites and a search engine.

14. Apparatus according to claim 9, wherein progress data is recorded in a database.

15. Apparatus according to claim 14, wherein said database encourages a best practice approach.

16. Apparatus according to claim 9, wherein commercially sensitive data is restricted, so as not be available to non-involved parties or to said authorities.
